(19) United States
(12) Patent Application Publication
(10) Pub. No.: US 2026/0179243 A1
(43) Pub. Date: Jun. 25, 2026

(54) Markerless Pose Tracking of Object Using Observed and Rendered Masks and Diffferential Rendering

(71) Applicant: Southwest Research Institute, San Antonio, TX (US)

(72) Inventors: David R. Chambers, Chickasha, OK (US); Omar D. Medjaouri, Boston, MA (US); Ahmed D. Fayed, Santa Clara, CA (US)

(21) Appl. No.: 18/988,699

(22) Filed: Dec. 19, 2024

(51) Int. Cl. G06T 7/70; G06T 7/10; G06T 7/80

(52) U.S. Cl. CPC G06T 7/70; G06T 7/10; G06T 7/80

(57) ABSTRACT

A system for determining the pose of an object. One or more cameras are arranged to provide images of an observed pose of the object from different perspectives of the object within a motion capture volume A segmentation process segments the images from each camera to provide an observed mask of the object from each image. A rendering process renders a digital twin of the motion capture volume and the object for each camera and generates rendered masks of the object. A mask alignment process aligns each observed mask with an associated rendered mask, thereby determining a rendered mask of the object that best matches an observed mask. The alignments are the basis of a transform process that orients the rendered object and its pose.

### BACKGROUND OF THE INVENTION

Motion capture is a process of recording real-world movements of objects (including humans) for realistic digital animations. It has become an essential technology for many applications, including computer animation, robotics, and biomechanics.

Pose estimation is a fundamental task in computer vision that involves detecting and tracking the position and orientation of objects in images or videos. The task of pose estimation can be distinguished from the simpler task of position estimation. While “position estimation” refers to determining an object's location in space, “pose estimation” goes further by identifying not only position but also the orientation of an object, essentially describing its full posture or “pose” in a scene.

In the past, motion capture was done with specialized markers, mounted on objects for tracking. These markers must be placed on every tracked object, and operators must define marker locations to establish frames of reference for each object. This process can be time-consuming, and in other cases the use of markers may be undesirable or completely infeasible.

In recent years, developers have devised new ways of tracking objects by using computer vision models and machine learning to identify sets of virtual markers (i.e., anatomical landmarks). This approach has several limitations. These virtual landmarks must be defined, and specialized models must be developed to recognize them.

### BRIEF DESCRIPTION OF DRAWINGS

FIG. 1 illustrates a system for determining the pose of a camera-observed object so that a digital twin of the object can be generated.

FIG. 2 illustrates the segmentation process of FIG. 1.

FIG. 3 illustrates the rendering process of FIG. 1.

FIGS. 4-6 illustrate the mask alignment process.

### DETAILED DESCRIPTION OF THE INVENTION

The following description is directed to a system and method for discerning (tracking) the pose of an object in a motion capture volume. It allows a digital twin of the object to be created from camera observation(s). The method does not require markers on the object.

The method combines machine learning segmentation, multiview geometry, and differentiable rendering. Cameras are used to acquire images from different perspectives, and a segmentation process provides “observation masks” from these images. A digital twin of the object and its motion capture system provides “rendered masks” of the same object. For each observed image, its observation mask is aligned with a rendered mask. The best alignment solves a transform function so that the digital twin can be property posed.

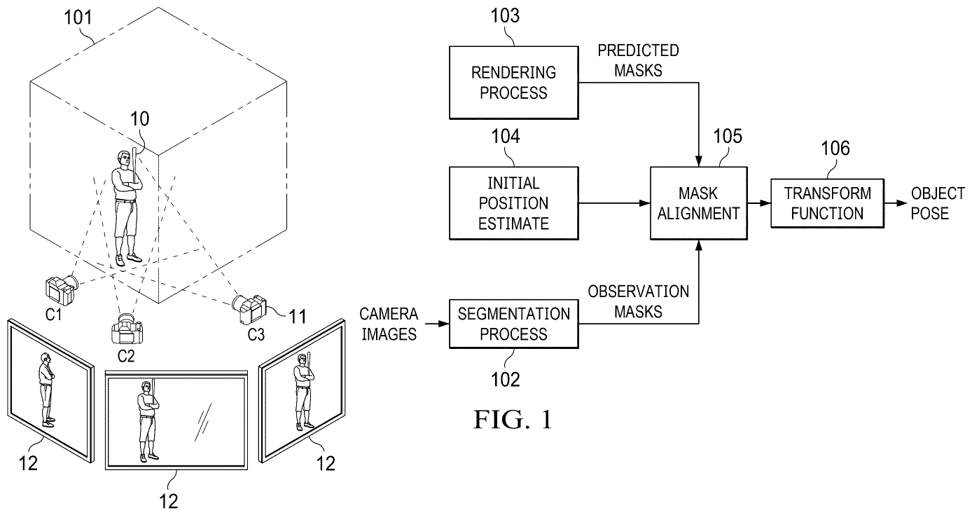

FIG. 1 illustrates a system for pose detection in accordance with the invention. A three-dimensional (3D) space of interest is defined within a fixed reference frame having known coordinates. This space is referred to herein as “motion capture volume” 101. An object of interest 10 is within volume 101, and for purposes of example herein, is a baseball bat being held by a human. A digital representation of the object (baseball bat) having its correct pose, one image frame at a time, within the motion capture volume is desired.

Preferably object 10 is an object that does not deform during motion, such as a rigid object. The object could be part of a larger articulated object.

One or more cameras 11 are arranged to view volume 101. In the example of FIG. 1, the system has three cameras 11. Each camera 11 provides a simultaneous and different image 12 of the object 10. In other words, each camera 11 provides an observation view of object 10 from a different perspective. In theory, the system could be implemented with a single camera 11, but as will become clear below, multiple cameras are preferable.

Cameras 11 are extrinsically calibrated such that their relative poses (to each other or to the reference frame) are known. They are also intrinsically calibrated, that is, their internal parameters are known for use when projecting 3D information into images. These parameters can include focal length, optical center, and lens distortion coefficients.

As further explained below, the system requires a digital model for detecting and segmenting the object of interest in a segmentation process 102. The system also requires a 3D digital model (twin) of the object of interest to be used in a differential rendering process 103. It is assumed that process 101 and process 102 and other processes described herein are implemented with appropriate hardware and software, programmed to perform the associated tasks described herein.

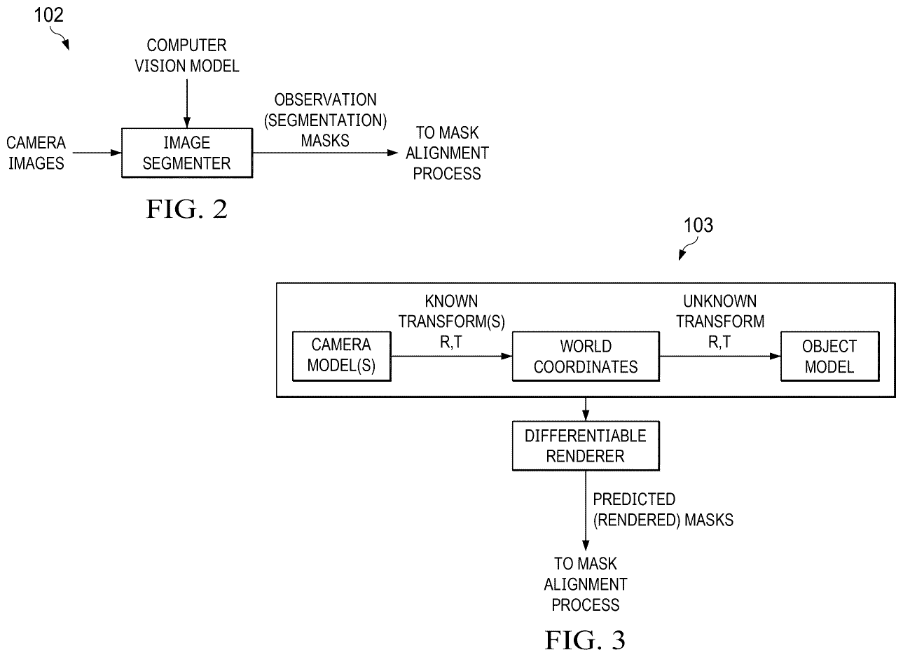

FIG. 2 illustrates the segmentation process 102. Camera images are acquired, and segmentation is performed on every image from every camera 11. In general, a semantic segmentation process creates a segmentation map of an input image. A segmentation map is, essentially, a reconstruction of the original image during which each pixel is labeled by its semantic class to create segmentation masks. A segmentation mask is a portion of the image that has been differentiated from other regions of the image. For example, in an image with multiple objects, the segmentation masks inform of which pixel belongs to which object.

Semantic segmentation process 102 may be implemented with techniques known in the art of computer vision. Neural networks analyze the image and extract relevant features and perform pixel classification whereby each pixel belongs to a category, which it is grouped into based on the extracted features. The masks provided by segmentation process 102 are referred to herein as “observation masks”.

Referring again to FIG. 1, an initial pose process 104 determines a crude location of the object 10 within volume 101. Using the camera calibrations and the observation masks, an estimation is made from an initial frame to determine a crude initial position of the object within motion capture volume 101. One approach to estimating an initial position is triangulated estimation. Triangulation can be done with two cameras, but it is also possible to achieve the estimation with a single camera. The initial position estimation might alternatively be achieved with a priori information.

FIG. 3 illustrates the differential rendering process 103. For each camera 11 in motion capture volume 101, a “predicted mask” is rendered using a presumed initial position of the object 10. As used herein, a “predicted mask” is a rendering of a mask of a digital twin of the object (a computer graphics model).

For rendering process 103, the camera images themselves are not inputs. However, each camera's properties are important. For each camera, the camera location in the digital twin world (extrinsic properties) and its projection parameters (camera intrinsic properties) are reproduced. In other words, for each camera, a digital twin of the entire motion capture system is generated, including a digital twin (model) of object 10.

Each rendering uses the known properties of each camera (camera intrinsic and extrinsic calibration) to generate a known transform to world coordinates. However, a transform to the object's pose with space 101 is unknown and to be determined.

In other words, the rendering process 103 seeks to provide a mathematical function of the object's pose. The objective is to find the unknown transform by minimizing a cost function. The primary objective is to minimize the cost function, indicating better alignment between observed masks and predicted masks.

In theory, a system having a single camera could be sufficient to perform the optimization, but the use of multiple cameras provides improved results. A shortcoming of a single-camera system is that a single observation of the object could result in complete or partial occlusion or lead to other error.

Thus, referring again to FIG. 1, a mask alignment process 105 solves for the object pose using an iterative optimization. For each frame, the optimization minimizes the difference between the observed (segmentation) masks and the predicted (rendered) masks.

The difference between the predicted masks and the observed masks can be aggregated over all pixels and all images to define a cost function. For each frame, a convex optimization process is run to refine the pose, aligning the rendered masks to the segmentation masks. The best match indicates the correct pose of the object, together with its rendered image and associated coordinates.

This rendering further reveals the transform function of the rendered image that best represents the observed object pose against a desired coordinate system, here the world coordinate system. The transform is from one frame of reference to another, that is, a translation, T, and a rotation, R. A transform process 106 is used to generate a digital image of the object with the motion capture volume 101.

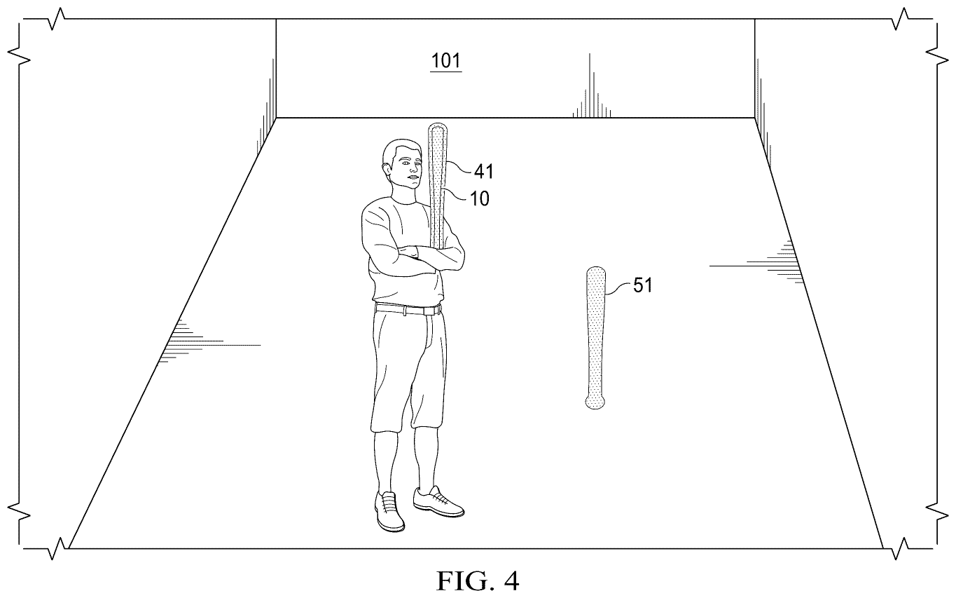

FIGS. 4-6 illustrate the mask alignment process, with the object being the baseball bat 10 consistent with the example of this description. The bat's observation mask 41 and predicted mask 51 are also shown. For purposes of illustration, the complete camera observation views (human and background) are also shown.

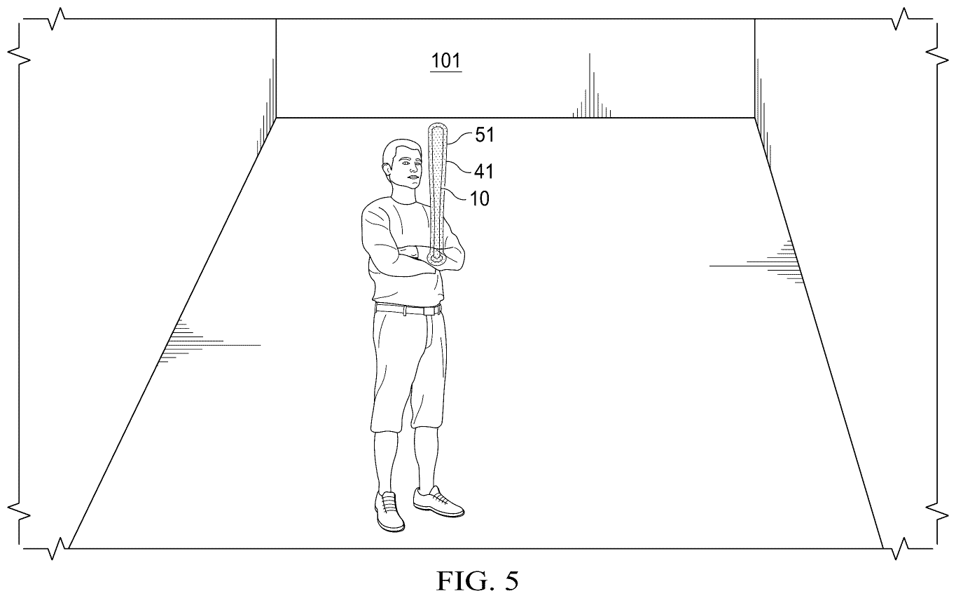

FIG. 4 represents a first camera (observation) view but the masks 41 and 51 are not aligned. FIG. 5 is the same observation view as FIG. 4, with the masks 41 and 51 aligned. The particular rotation and translation of the digitized motion capture volume needed to achieve the alignment of FIG. 5 represents the transform for the proper pose of the bat and for the entire motion capture space to be digitally reproduced.

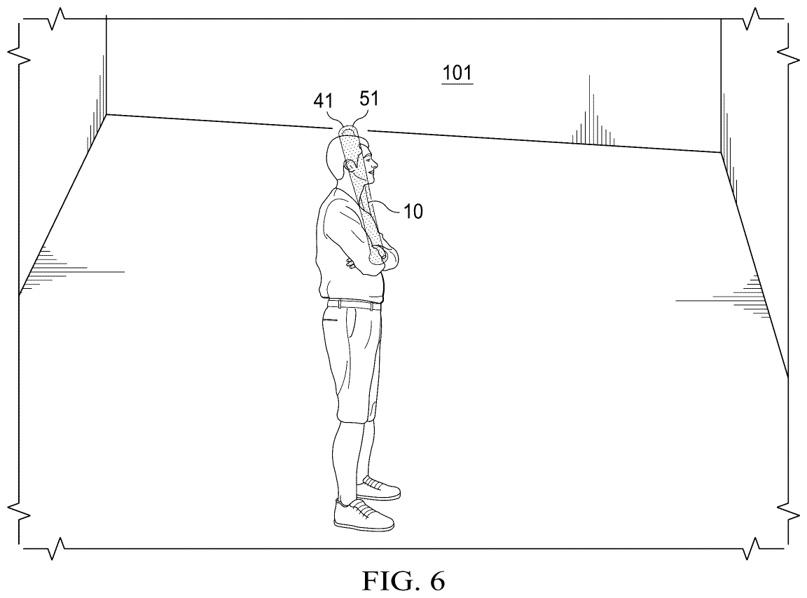

FIG. 6 illustrates the observation view of a different camera from that of FIGS. 4 and 5. In FIG. 6, the masks 41 and 51 are aligned but the observation mask 41 is partially occluded by the human. FIG. 6 illustrates the advantage of having multiple camera views.

Once the pose for a single frame is determined, successive frames can be processed. The object's motion is thereby tracked over time. Each frame is processed sequentially so that the solution of the prior frame is used as the initial pose guess in each optimization.

Although the foregoing description is in terms of tracking a single rigid object, the same concepts could be extended to multiple objects in an image or to objects that are part of a larger articulated object. Observed and rendered masks would be generated for each tracked object, and the tracking process performed for each object. More than one object in an image can be masked and its observed and rendered masks aligned.

1. A system for determining the pose of an object located in a motion
capture volume, comprising:
one or more cameras arranged to provide images of an observed pose of the object from different perspectives of the object within the motion capture volume;
wherein the one or more cameras are externally calibrated such that their relative camera poses are known and the intrinsic properties of each camera are known;
a segmentation process programmed to segment the images from each camera to provide an observed mask of the object from each of the images;
a rendering process programmed to render a digital twin of the motion capture volume and the object for each of the one or more cameras and to generate rendered masks of the object;
a mask alignment process programmed to align each observed mask with an associated rendered mask, thereby determining a rendered mask of the object that best matches an observed mask;
a transform process that uses the results of the mask alignment process to provide a rendered image of the object.

2. The system of claim 1, wherein the mask alignment process is preceded by an initial estimate of the position of the object within the motion capture space.

3. The system of claim 2, wherein the initial position is estimated based on camera calibrations and two or more observed masks.

4. The system of claim 1, wherein the object is a rigid object.

5. The system of claim 1, wherein the object is a part of a larger object.

6. The system of claim 5, wherein the object is an articulated object.

7. The system of claim 1, wherein the motion capture volume has more than one object and segmentation process and rendering process produce observed masks and rendered masks for the more than one object, and the alignment process and transform process are repeated for each of the multiple objects.
